(19) United States
(12) Patent Application Publication
(10) Pub. No.: US 2026/0340270 A1
(43) Pub. Date: Oct. 29, 2026

(54) CROSS-DEVICE AND TIME-INDEPENDENT FORM COMPLETION SYSTEM

(71) Applicant: American Express Travel Related Services Company, Inc., New York, NY (US)

(72) Inventors: Kartik VENKATARAMAN, Bengaluru (IN); Maanas Srisai BUKKURI, Riverside, CA (US); Sujay UDUPA, Bengaluru (IN)

(21) Appl. No.: 19/191,978

(22) Filed: Apr. 28, 2025

(51) Int. Cl. G06F 40/174; G06K 7/14; G06K 19/06; H04L 9/40

(52) U.S. Cl. CPC G06F 40/174; G06K 7/1417; G06K 19/06037; H04L 63/083

(57) ABSTRACT

Disclosed herein are system, method, and computer program product embodiments for form data management. Embodiments include providing, to a first user device, a digital form comprising a plurality of fields, receiving, from the first user device, form data associated with one or more fields of the plurality of fields, associating the form data with an identifier, receiving, from a second user device or the first user device, a request for the form data, and transmitting in response to receiving the request the form data to the second user device to populate the one or more fields of the plurality of fields.

### BACKGROUND

Digital forms may be used to collect information from one or more users. For example, a customer wishing to apply for a loan or open a bank account may likely be provided with a digital form to collect the information required by the financial entity such as first name, last name, middle initial, street address, telephone number, a social security number, and the like. In addition, the user may be prompted to upload via the digital form one or more documents (e.g., a copy of the tax return). The manual entry of information into the digital form is time-consuming such that the customer may not be able to complete and submit the digital form in one session. In addition, the user may desire to navigate away from the digital form in order to collect the required information which may result in errors and loss of all typed information.

Information required in the digital form may include sensitive information that are distributed among multiple employees or departments of a corporate entity. In addition, multiple employees may desire to access the digital form to review the filled information or sign the forms. However, a technical challenge relates to sharing and accessing the form in a secure and seamless manner.

### SUMMARY

Disclosed herein are system, apparatus, device, method and/or computer program product embodiments, and/or combinations and sub-combinations thereof, for storing and accessing user-fillable forms.

In some embodiments, a method may include providing, to a first user device, a digital form comprising a plurality of fields, receiving, from the first user device, form data associated with one or more fields of the plurality of fields, associating the form data with an identifier, receiving, from a second user device, a request for the form data, and transmitting and in response to receiving the request the form data to the second user device to populate the one or more fields of the plurality of fields.

In some embodiments, a system comprises a memory and at least one processor coupled to the memory. The at least one processor is configured to provide, to a first user device, a digital form comprising a plurality of fields, receive, from the first user device, form data associated with one or more fields of the plurality of fields, associate the form data with an identifier, receive, from a second user device, a request for the form data, wherein the request includes the identifier, and transmit in response to receiving the request the form data to the second user device to populate the one or more fields of the plurality of fields.

Certain aspects of the disclosure have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

The accompanying drawings, which are incorporated herein and form a part of the specification, illustrate aspects of the present disclosure and, together with the description, further serve to explain the principles of the disclosure and to enable a person skilled in the art to make and use the aspects.

FIG. 1 is a block diagram of an environment for a system for managing data associated with digital forms, in accordance with an embodiment of the present disclosure.

FIG. 2 is a schematic that illustrates a user flow for managing data associated with digital forms, in accordance with an embodiment of the present disclosure.

FIG. 3 is a schematic that illustrates a data flow for managing data associated with digital forms, in accordance with an embodiment of the present disclosure.

FIG. 4 is an example method for capturing data using a digital form, in accordance with an embodiment of the present disclosure.

FIG. 5 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

The following aspects are described in sufficient detail to enable those skilled in the art to make and use the disclosure. It is to be understood that other aspects are evident based on the present disclosure, and that system, process, or mechanical changes may be made without departing from the scope of an aspect of the present disclosure.

In the following description, numerous specific details are given to provide a thorough understanding of aspects. However, it will be apparent that aspects may be practiced without these specific details. To avoid obscuring an aspect, some well-known circuits, system configurations, and process steps are not disclosed in detail.

Certain aspects have other steps or elements in addition to or in place of those mentioned. The steps or elements will become apparent to those skilled in the art from a reading of the following detailed description when taken with reference to the accompanying drawings.

Aspects of the present disclosure relate to systems and methods for seamlessly competing digital fillable forms across different devices at different times by utilizing a network-based session persistence mechanism.

As described in the background, a partially filled digital form received from a user device may need to be stored and accessed at a later time from the same user device or a different user device. In addition, an enterprise may desire to collect information from customers or a company. The information may include sensitive data. The information needed to complete the digital form may be distributed among multiple persons and/or departments of the company. In some aspects, other users or departments may need to review or sign off on one or more sections of the digital form before the digital form is submitted to the enterprise.

However, a technical challenge relates to maintaining data associated with partially filled or incomplete digital forms in a secure manner and accessing the data from multiple user devices by one or more users and across different time periods (time independent). Provided herein is a system configured to store data associated with partially filled digital forms in a distributed manner that facilitates access to the partially filled digital forms from multiple user devices. The data may be accessed by one or more users from one or more user devices without requiring that the one or more users create an account associated with the system and/or require that the one or more users use login credentials. The data and the form data may be protected using a password to secure the information.

Whereas previously, a user may be required to create an account to access a platform to retrieve a document, aspects of the present disclosure improve upon prior art systems by providing a system to store partially completed digital forms or un-submitted digital forms and accessing the data from any device using a unique identifier such as a quick response (QR) code or a uniform resource locator (URL). The QR code or the URL may be distributed among other users to access the partially completed digital form. Using a QR code to access the digital form provides the additional advantage of ease of use (e.g., avoiding the risk of the URL being blocked due to security policies of company of the user).

The present disclosure provides an improvement in the technologies of data storage and capturing data by providing a process to access data associated with a digital form using any device seamlessly (e.g., without creating an account). In addition, unauthorized access to the data is minimized by storing the data in a data store separate from a data store associated with the form provider.

In some aspects, a user may stop the process of completing an online form to attend to other activities. For example, a user may start the process of filling a digital form associated with an application for a credit card or a loan application. It may challenging to continue filling the digital form using another device without restarting the process. In one example, the user may fill up about 80% of the form on a desktop computer before interrupting the process to catch a train. Using the methods described herein, the user may switch to a mobile device to continue the process of filling the digital form. As discussed above, data entered in the form may compromise personal information data. The data associated with the form is securely stored to reduce the risk of compromising the data.

In another example, the user may fill a portion of the form using a first device before realizing that documents need to be attached to the digital form. The needed documents may be in a physical form and there is no scanner coupled to the first device. The user may switch to a second device such as a smartphone and use a camera of the second device to scan and upload the documents. The journey is not broken and is seamless for the user.

In another example, the digital form may need to be completed by multiple persons (e.g., a customer and a salesperson, a doctor and a patient). The first person may fill their corresponding part and save the form using a first device. The second person may scan the QR code presented on the first device using a second device and complete their respective part of the digital form using the second device.

In another example, the form may be associated with a customer of an entity (e.g., a cardholder). For example, the customer may invite friends and family to apply for the same credit card. The form may be shared by the customer with friends and family. The form may have prefilled information by the customer such as a discount code or a type of the product (e.g., name of the credit card).

The systems and methods described herein provide the technical advantage of a cross-device platform that enables sharing securely a digital form between multiple devices and/or multiple users seamlessly in a time-independent manner. Securely sharing form parameters does not require creating an account with a third party provider. Digital forms may be accessed across the multiple devices without the need for creating credentials to login to an account. In addition, the data is stored safely within the system and does not have to be uploaded to the third party provider.

In addition, the present disclosure provides the advantage of increasing the engagement with customers and reducing drop rates. For example, a user applying for a credit card may realize that it takes longer than expected to complete the digital form associated with the application and may not restart the process if the user is interrupted. By providing the user with an option to continue filling the application at a later time or on the go from another device without having to create an account, the engagement with the customer is increased and the drop rate is decreased.

A digital form may refer to an online fillable form. Fillable form is a document with fields also referred to as placeholders in which to write or select one of the proposed options. Data collected by the digital form may refer to text data, selections of one or more options in the digital form, images, and uploaded files. In addition, the digital form may include multiple pages and/or multiple sections.

Various embodiments of these features will now be discussed with respect to the corresponding figures.

### System Overview and Function

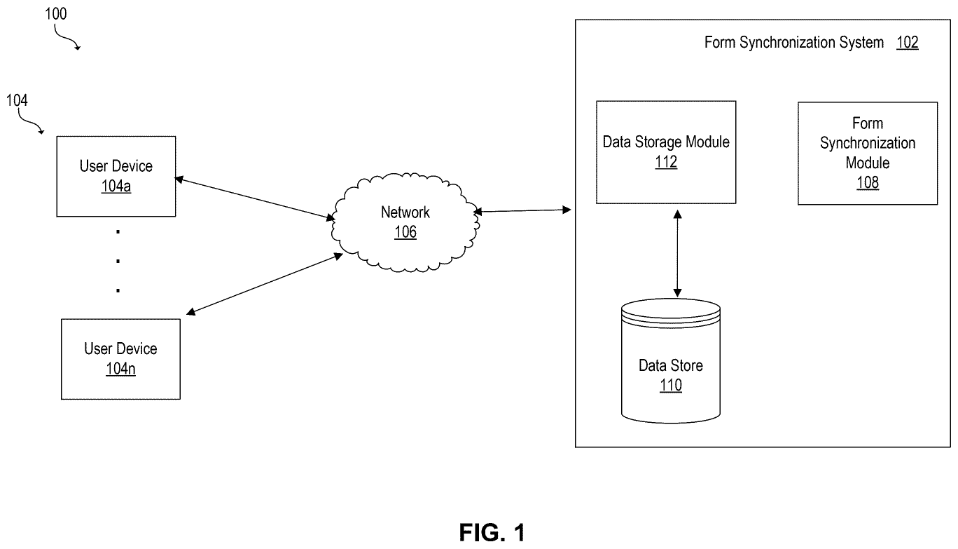

FIG. 1 is a block diagram of an environment 100 for a form synchronization system 102 for collecting data using a digital form, in accordance with an embodiment of the present disclosure. Environment 100 may include form synchronization system 102, user devices 104 (e.g., user devices 104a . . . 104n), and a network 106. Form synchronization system 102 may collect data from one or more users via digital forms.

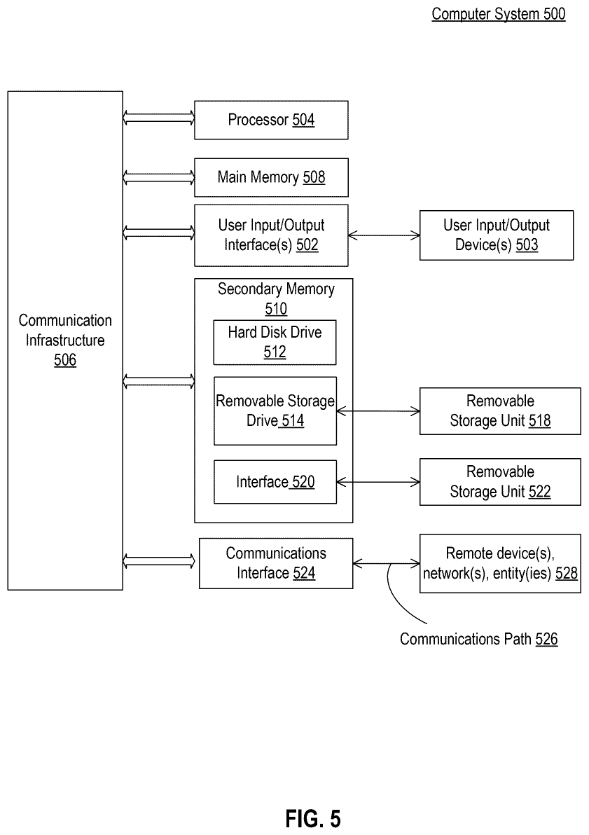

Form synchronization system 102 may provide a cluster computing platform or a cloud computing platform to collect and store data associated with a digital form. System 102 may operate on one or more servers and/or databases. The servers may be a variety of centralized or decentralized computing devices. For example, a server may be grid-computing resources, a virtualized computing resource, peer-to-peer distributed computing devices, a mobile device, a laptop computer, a desktop computer, or a combination thereof. The servers may be centralized in a single room, distributed across different rooms, distributed across different geographic locations, or embedded within network 106. In some aspects, form synchronization system 102 may be implemented using computer system 500 described with reference to FIG. 5.

In some aspects, system 102 may include a form provider module 108, a data store 110, and a data storage module 112. Form synchronization system 102 may be associated with an entity. For example, system 102 may be associated with a financial entity. User devices 104a-n may interact with form synchronization system 102 to provide information related to digital forms. In some aspects, the user may access a webpage associated with form synchronization system 102. In response to receiving an input from the user, form provider module 108 may provide a digital form to the user via the webpage to collect the data associated with the loan application. As described above, the digital form (e.g., eForm) is used to gather data from the user. The data may include information about the user and one or more digital files (e.g., scanned identification documents, copy of tax documents, or the like). In response to the user submitting the form, form provider module 108 may process the data and transmit the data to other integration systems for further processing.

Form provider module 108 may be a computer system such as computer system 500 described with reference to FIG. 5. Form synchronization module 108 may include input output (I/O) devices, one or more processors, and a memory such as computer readable media.

As described herein, user device 104 may interact with form synchronization module 108. User device 104 may be a computer system such as computer system 500 described with reference to FIG. 5. For example, user device 104 may be any variety of electronic devices, such as a mobile device (e.g., smartphone, tablet, pager, personal digital assistant (PDA)), a computer (e.g., a laptop computer, a desktop computer, a server), and/or a wearable device (e.g., a smartwatch). User device 104 may include one or more processors and/or memory. User device 104 may interact with form synchronization system 102 to fill one or more digital forms and to submit to the digital forms to form synchronization system 102.

As describe above, the user may desire to switch devices while completing the digital form, send the digital form to another user, or pause completing the digital form without risking losing the entered data. Form synchronization module 108 may provide the digital form with at least two controls or GUI objects to save and to submit the data. Upon the user selecting to save the form, form synchronization system 102 may generate a unique identifier for the form. In some aspects, form synchronization module 108 may generate the unique identifier associated with the form. The form data may be uploaded to data storage module 112. Data storage module 112 may store the form data. Data storage module 112 may associate the form data with the unique identifier. Data storage module 112 may transmit the form data to the user device in response to receiving the unique identifier from a user device. In some aspects, form synchronization system 102 may prompt the user to enter a passcode to protect unauthorized access to the form data.

In some aspects, in order to preserve the data integrity before the user submits the forms, the data associated with incomplete forms (before the form is submitted by the user) is stored in a data store separate from where data associated with submitted forms is stored. In some aspects, form synchronization system 102 may include a plurality of data stores. In some aspects, data associated with incomplete and/or un-submitted forms may be stored in data store 110.

User device 104 may access form synchronization system 102 and data storage module 112 via an application programming interface (API) command or call. As used herein, the API may comprise any software capable of performing an interaction between one or more software components as well as interacting with and/or accessing one or more data storage elements (e.g., server systems, databases, hard drives, and the like). An API may comprise a library that specifies routines, data structures, object classes, variables, and the like. Thus, an API may be formulated in a variety of ways and based upon a variety of specifications or standards, including, for example, POSIX, the MICROSOFT WINDOWS API®, a standard library such as C++, a JAVA API, REST and the like.

Form synchronization system 102 and user device 104 may communicate via network 106. Network 106 may be a telecommunications network, such as a wired or wireless network. Network 106 can span and represent a variety of networks and network topologies. For example, network 106 can include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in network 106. Cable, Ethernet, digital subscriber line (DSL), fiber optic lines, fiber to the home (FTTH), and plain old telephone service (POTS) are examples of wired communication that may be included in network 106. Further, network 106 can traverse a number of topologies and distances. For example, network 106 can include a direct connection, personal area network (PAN), local area network (LAN), metropolitan area network (MAN), wide area network (WAN), or a combination thereof.

In some aspects, an identifier associated with the digital form may be encoded in a QR code. QR codes are two-dimensional bar codes that can encode information. Form synchronization system 102 (e.g., form synchronization module 108) may generate the QR code that encodes the identifier of the form. The QR code may be read by mobile devices having a QR-reader application and a camera. For example, the user may access the partially completed form by scanning the QR code with a camera of user device 104n. A QR-reader application running on user device 104n may decode the QR code scanned by the camera and extracts a universal resource locator (URL) or other web-address encoded in the QR code. The reading of the QR code requires a direct line-of-sight between the QR code and the QR reader/camera, to enable the camera to obtain an image of the code. Thus by avoiding sharing the identifier through communication channels the risk of compromise is reduced. The QR code can be kept secure by limiting the period of time it is displayed on a display screen of user device 104a.

In some aspects, the identifier of the digital form may include an URL. The URL may be a universal link URL that opens the digital form in a browser of user device 104n. The URL may be transmitted to user device 104n by way of one or more of: e-mail, instant messaging, Bluetooth, or near field communication

As discussed above, the digital form may include multiple sections to be completed by different individuals. Each individual may access the form using their respective user device. The QR code and/or the URL may be shared with the other individuals. If the digital form is passcode protected, the passcode may also be shared among the users. In some aspects, the passcode may be shared using a method different than the method used to share the QR code and/or the URL to minimize the risk of compromise. For example, the URL may be shared via email and the passcode may be shared via a text message.

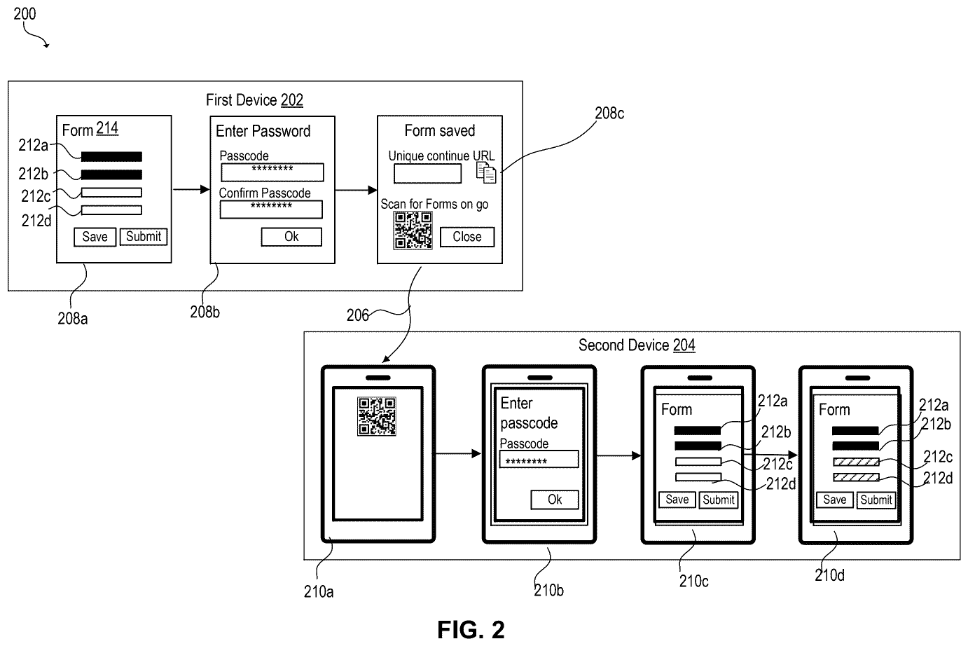

FIG. 2 is a schematic that illustrates a user flow 200 for managing data associated with digital forms, in accordance with an embodiment of the present disclosure. Flow 200 illustrates a hand off of a digital form 214 between a first device 202 and a second device 204. First device 202 and second device 204 may correspond to user devices 104 described in FIG. 1. In the example shown, first device 202 may provide digital form 214 via a browser. First device 202 is configured to receive user input comprising data to fill digital form 214. Second device 204 is configured to provide an application configured to receive user input comprising data to continue the process of filling digital form 214. However, this is a non-limiting example. As discussed above, first device 202 may interact with form synchronization system 102. In some aspects, user device 202 displays a landing page for data ingestion using digital form 214. As shown in user interface 208a of first device 202, digital form 214 may comprise multiple fields. As a non-limiting example, digital form 214 may include four fields: a first field 212a, a second field 212b, a third field 212c, and a fourth field 212d. The user may input data to first field 212a and second field 212b. In FIG. 2, the filled fields are shown with a solid fill.

In addition to form 214, the landing page may also comprise one or more GUI objects. The one or more GUI objects comprise a “save” GUI object and a “submit” GUI object. Upon receiving a user input indicating selection of the “save” GUI object, user device 202 is configured to present user interface 208b. User interface 208b comprises one or more fields to receive a user input comprising a password or passcode as shown in user interface 208b. User interface 208b may include an “ok” GUI object to submit the entered password to data storage module 112. The entered password is used to protect the form data entered by the user. User device 202 receives a user input indicating selection of the “ok” GUI object and is configured to present user interface 208c. In some aspects, user interface 208c may provide the user with one or more methods to access the form and the form data at a later time. The form data may refer to text data, selections of one or more options in the form, images, and uploaded files. Form synchronization module 108 may generate a unique identifier for the digital form. In some aspects, the unique identifier may be in the form of a unique URL or a QR code. The QR code and the URL may identify the form and may be used to retrieve the form from data storage module 112. The unique URL and/or the QR code may be presented to the user as shown in interface 208c.

In some aspects, the user may access form 214 from a second device 204. At 206, form 214 may be handed off from first device 202 to second device 204. Second device 204 may have an installed application that includes a scanning feature for establishing a link between a form-filling application on the first device or a browser of first device 202. In some aspects, user device 202 may present a QR code on user interface 208c. A camera or a QR reader of second device 204 may scan the QR code. In some aspects, second device 204 may receive a user input indicating the URL. The URL may open the digital form in a browser of second device 204. In some aspects, the URL or the QR code may direct the user to an interface that prompts the user to enter a passcode to open the digital form.

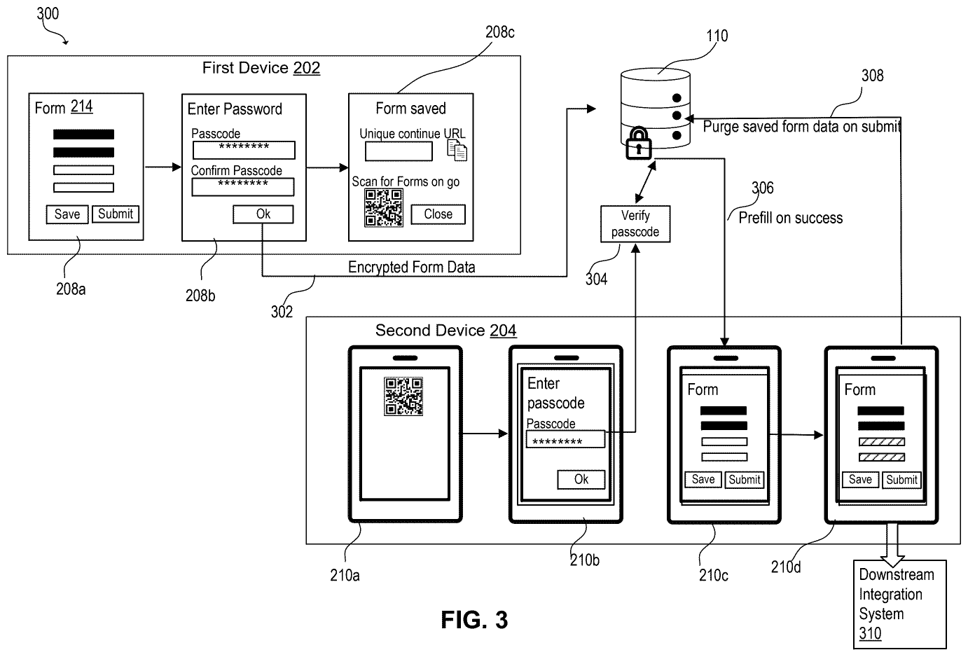

In response to receiving the QR code as shown in interface 210a, second user device 204 is configured to present user interface 210b. User interface 210b comprises a GUI object such as a text box to input a password associated with form 214. Once second device 204 received user input comprising a password, second device 204 is configured to present user interface 210c. User interface 210c shows form 214 and the data form that have been previously entered by the user. For example, first field 212a and second 212b are prefilled with the data form received from data store 110 as further described in FIG. 3. As shown in interface 210d, second device 204 may receive user input comprising additional data corresponding to the remaining fields (e.g., third field 212c and field 212d). As discussed above, user interface 210 may include the “submit” GUI object. Second device 204 receives user input indicating selection of the “submit” GUI object, second device 204 may submit the form data to form synchronization module 108 for further processing. Second device 204 receives the user input when form 214 is completed.

In some aspects, form data may be passed directly between first device 202 and second device 204 without connection to network 106. In some aspects, the form data may be transferred via Bluetooth, or near-field communication. The identifier for the form may be encoded in the QR code.

FIG. 3 is a schematic that illustrates a data flow 300 for managing data associated with digital forms, in accordance with an embodiment of the present disclosure. As discussed in relation with FIG. 2 above, first device 202 may receive user input comprising data to fill form 214 using an interface of the first device 202. In some aspects, first device 202 may be configured to automatically store locally the data in a memory of first device 202. In addition or alternatively, the form data may be uploaded periodically to form synchronization system 102. In some aspects, as first device 202 receives user input for the form, form synchronization system 102 may automatically save the progress in a cloud network. This provides the advantage that the any version of the form is available for retrieval at any time.

As discussed above, user interface 208 may include the “save” GUI object and the “submit” GUI object. First device 202 receive a user input indicating selection of the “save” GUI object and is configure to present an interface to enter a password or passcode as shown in user interface 208b. First device 202 may receive user input indicating the passcode. In some aspects, first device 202 may prompt the user to input the desired password twice. First device 202 may receive user input indicating selection of the “ok” GUI object and is configured to determine whether the entered passwords match by comparing the input of the two fields. In response to determining that the entered passwords match, the form data may be encrypted and transmitted to data storage module 112. The encrypted form data may be stored in data store 110. In some aspects, first device 202 may encrypt and transmit the form data to data storage module 110. In some aspects, form synchronization system 102 may encrypt the data and store the encrypted data in data store 110. In some aspects, other forms of authentication may be used in addition to or alternatively to the password. For example, biometrics (e.g., fingerprint, facial scan), one-time passwords (OTPs), combinations of a unique biometric identifier with an OTP, multi-factor authentication, token-based authentication, or certificate based authentication may be used.

In some aspects, form synchronization module 108 may generate the unique identifier. The unique identifier may be in the form of a unique URL link or a QR code. The QR code and the URL link may identify the form and may be used to retrieve the form data from data storage module 112. In some examples, the QR code may also encode additional information such as the time and/or date at which the QR code was generated. In some aspects, when the user has an account with form synchronization system 102, the QR code may also encode the user account information. The system may store the encrypted data and the encrypted passcode in data store 110. In some aspects, data storage module 112 may also associate a unique identifier of the user and/or first device 202 with the encrypted form data. For example, a serial number of user device 202 may be retrieved and transmitted with the encrypted form data. The serial number of user device 202 may be associated with the encrypted form data in data store 110. In addition to associating the unique identifier of the user and/or first device 202, data storage module 112 may associate a timestamp with the form data. Using the timestamp and the unique identifier of the user and/or user device 202, form synchronization system 102 may create a timeline of all users and all user devices that accessed the form data.

In some aspects, form synchronization system 102 may initializes a unique session ID when a user starts completing a form on first device 202. The unique session ID may be stored in data store 110 with the unique identifier and the timestamp and associated with the form data. A notification to the user that the data have been successfully saved in data storage module 112 may be generated and rendered on a display of first device 202.

In some aspects, the unique identifier may be generated by first device 202. For example, first device 202 may be running an application associated with form synchronization system 102. The application may be configured to display the digital form on the user device. The application may be configured to generate QR codes corresponding to the digital form provided to the user of the application. Alternatively, the application may generate QR codes for a digital form being filled by the user.

In some aspects, once the QR code is generated, first device 202 may display the QR code on a display screen of first device 202. In some aspects, the application running on first device 202 may display the QR code. Second device 204 is configured to scan the QR code using a camera or a QR reader. In another example, second device 204 may receive a user input comprising the unique URL link and is configured to open the unique URL link in a browser.

In some aspects, a processor or a QR reader application of second device 204 may process the QR code to retrieve the information encoded therein. For example, the QR reader application may extract an identifier of the form. In response to extracting the identifier of the form, second device 204 may present a user interface to receive a passcode associated with the form. Second device 204 may receive user input indication selection of an “ok” GUI object and is configured to transmit the passcode to data storage module 112. For example, second device 204 may transmit the passcode to data storage module 112. In 304, data storage module 112 may compare the received passcode with the passcode stored in data store 110. For example, using the unique identifier, data storage module 112 may retrieve the stored passcode form data store 110. In response to determining that the passcodes match, form synchronization system 102 may render the partially filled form on second device 204. In some aspects, data storage module 112 may transmit the stored form data to prefill the digital form at 306.

In some aspects, form synchronization system 102 may adjust the form's layout and input fields dynamically to match the screen size and capabilities of the new device (e.g., mobile, tablet, desktop). The form synchronization system 102 may reformat fields, buttons, and navigation to optimize the user experience.

In some aspects, the form may not be protected with a passcode. For example, if the form does not include personal information. The QR code may be generated and the form data may be transmitted to form synchronization system 102 without using a passcode. Second device 204 may retrieve the form data of digital form 214 by acquiring the QR code or receiving a user input indicating the URL. In addition to acquiring the form data, second device 204 may also acquire associated session data. The form may open at the exact point where the user left off ensuring a seamless continuation. For example, if the form comprises multiple pages, the form may open to the page where the user left off.

As discussed above in addition to the “save” GUI object, user interface 210c may comprise a “submit” GUI object. Second device 202 receives user input indicating the selection of the “submit” GUI object and is configured to transmit the selection to form synchronization system 102. Form synchronization system 102 may purge the stored form data in data store 110. In 308, data storage module 112 may purge the stored form data form data store 110. The form data may be transmitted to a downstream integration system 310 for further processing (e.g., process the loan application).

In some aspects, form synchronization system 102 may check periodically whether the data stored in data store 110 satisfies one or more purging conditions. For example, the data may be deleted from data store 110 after a predefined period (e.g., one month). The one or more conditions may be set by form synchronization module 108.

In some aspects, session data is stored with a configurable expiration period, allowing users to pause their progress and return at a later time, even days or weeks after the initial input. Notifications or reminders can be sent to prompt users to complete the form if desired.

In some aspects, user interface 210 may comprise additional GUI objects. Form synchronization system 102 may provide the user with a “review and submit” GUI object. Upon receiving a user input indicating selection of the “review and submit” GUI object, form synchronization system 102 may present the user with an interface to review the completed forms and the uploaded files. Alternatively, an interface to review the form may be presented on second device 204 upon receiving a user input indicating selection of the “submit” GUI object.

Flow 300 may be repeatedly and/or sequentially performed at a plurality of user devices. For example, in response to selecting the “save” GUI object at interface 210c, form synchronization system 102 may generate another unique identifier and the data is stored in data store 110. The process may be repeated until the user completes and submits the digital form. In addition, the user may be prompted to enter a new pass code after selecting the “save” GUI object.

In some aspects, user device 104 may display the digital form from the same user device but from a different browser. User device 104 can also switch from providing the digital form via a webpage associated with form synchronization module 108 to an application associated with form synchronization module 108 on the same user device.

### Methods of Operation

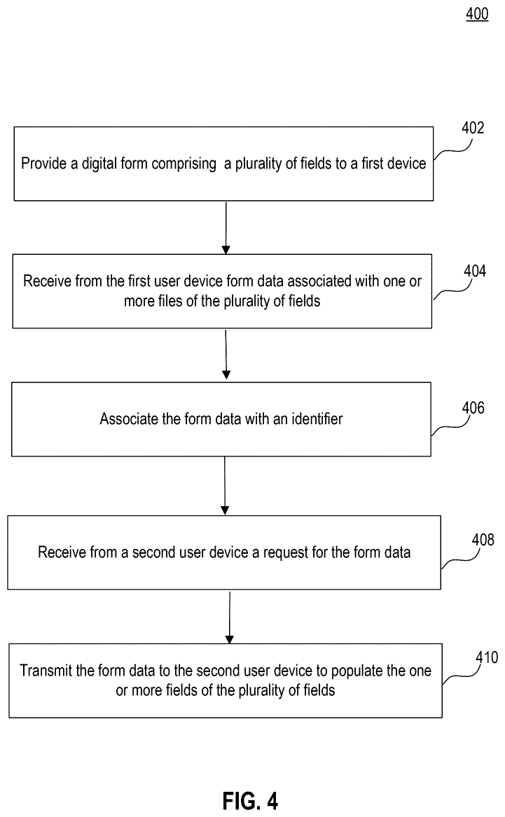

FIG. 4 is an example method 400 for capturing data using a digital form, in accordance with an embodiment of the present disclosure. Method 400 may be performed as a series of steps by a computing unit such as a processor. For example, method 400 may be implemented by form synchronization system 102 and/or computer system 500 of FIG. 5. Method 400 shall be described with reference to FIG. 1, however, method 400 is not limited to that example embodiment.

In 402, form synchronization system 102 may provide to a first user device (e.g., user device 104a) a digital form comprising a plurality of fields.

In 404, form synchronization system 102 may receive from the first user device form data associated with one or more fields of the plurality of fields. The form data may include one or more digital files. In some aspects, form synchronization system 102 may generate a QR code. The QR code may include a unique identifier for the form data. First user device may display the QR code. In some aspects, form synchronization system 102 may generate a URL. The URL may include the unique identifier. First user device may transmit to other user devices the URL via one or more of: e-mail, instant messaging, Bluetooth, or near field communication.

In 406, form synchronization system 102 may associate the form data with the identifier.

In 408, form synchronization system 102 may receive from a second user device (e.g., user device 104n) a request for the form data. The request includes the identifier.

In 410, form synchronization system 102 may transmit the form data to the second user device to populate the one or more fields of the plurality of fields. In some aspects, the form data may be protected with a passcode. Form synchronization system 102 may prompt the user to enter a passcode before transmitting or populating the form data. For example, form synchronization system 102 may compare the passcode entered by the user with a stored passcode associated with the form data.

In some aspects, form synchronization system 102 may determine a state of the form data stored in data store 110. For example, form synchronization system 102 may determine whether the form data have been submitted. In response to determining that the form data have been submitted, form synchronization system 102 may purge the form data from the data store. Form synchronization system 102 may also determine whether the form data have not been accessed for longer than a threshold period. Form synchronization system 102 may purge form data that have not been accessed for a period that exceeds the threshold period.

It is to be appreciated that not all steps may be needed to perform the disclosure provided herein. Further, some of the steps may be performed simultaneously, or in a different order than shown in FIG. 5, as will be understood be a person of ordinary skill in the art.

### Components of the System

Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof. For example, the method steps of FIG. 4 may be implemented via computer system 500.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a secondary storage device 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method, comprising:
providing, to a first user device by at least one processor, a digital form comprising a plurality of fields;
receiving, from the first user device by at least one processor, form data associated with one or more fields of the plurality of fields;
associating, using the at least one processor, the form data with an identifier;
receiving, from a second user device or the first user device by the at least one processor, a request for the form data, wherein the request includes the identifier; and
transmitting, by the at least one processor and in response to receiving the request, the form data to the second user device to populate the one or more fields of the plurality of fields.

2. The computer implemented method of claim 1, further comprising:
before transmitting the form data to the second user device, comparing a first passcode received from the second user device with a stored passcode, wherein the stored passcode is associated with the form data; and
in response to determining that the first passcode matches the stored passcode, transmitting the form data to the second user device.

3. The computer implemented method of claim 1, further comprising:
storing the form data in a data store;
detecting a state of the digital form; and
in response to determining that the state of the form is submitted, purging the form data from the data store.

4. The computer implemented method of claim 1, further comprising:
generating a quick response (QR) code associated with the form data, wherein the QR code includes the identifier.

5. The computer implemented method of claim 4, further comprising:
displaying the QR code on a display of the first user device.

6. The computer implemented method of claim 5, further comprising:
reading, by a QR reader of the second user device, the QR code generated by the first user device; and
processing the QR code read by the QR reader in order to extract the identifier corresponding to the form data of the digital form.

7. The computer implemented method of claim 1, further comprising:
generating a uniform resource locator (URL), wherein the URL specifies the identifier of the digital form, and wherein the URL is transmitted to the second user device by way of one or more of: e-mail, instant messaging, Bluetooth, or near field communication.

8. The computer implemented method of claim 7, further comprising:
accessing the URL for the digital form by a browser on the second user device.

9. The computer implemented method of claim 1, wherein the form data comprises one or more digital files.

10. A system, comprising:
a memory; and
at least one processor coupled to the memory and configured to:
provide, to a first user device, a digital form comprising a plurality of fields;
receive, from the first user device, form data associated with one or more fields of the plurality of fields;
associate the form data with an identifier;
receive, from a second user device or the first user device, a request for the form data, wherein the request includes the identifier; and
transmit, in response to receiving the request, the form data to the second user device to populate the one or more fields of the plurality of fields.

11. The system of claim 10, wherein the at least one processor is further configured to:
before transmitting the form data to the second user device, compare a first passcode received from the second user device with a stored passcode, wherein the stored passcode is associated with the form data; and
in response to determining that the first passcode matches the stored passcode, transmit the form data to the second user device.

12. The system of claim 10, wherein the at least one processor is further configured to:
store the form data in a data store;
detect a state of the digital form; and
in response to determining that the state of the form is submitted, purge the form data from the data store.

13. The system of claim 10, wherein the at least one processor is further configured to:
generate a quick response (QR) code associated with the form data, wherein the QR code includes the identifier.

14. The system of claim 13, wherein the at least one processor is further configured to:
display the QR code on a display of the first user device.

15. The system of claim 14, wherein the at least one processor is further configured to:
read, by a QR reader of the second user device, the QR code generated by the first user device; and
process the QR code read by the QR reader in order to extract the identifier corresponding to the form data of the digital form.

16. The system of claim 10, wherein the at least one processor is further configured to: generate a uniform resource locator (URL), wherein the URL specifies the identifier of the digital form, and wherein the URL is transmitted to the second user device by way of one or more of: e-mail, instant messaging, Bluetooth, or near field communication.

17. A non-transitory computer-readable device having instructions stored thereon that, when executed by at least one computing device, cause the at least one computing device to perform operations comprising:
providing, to a first user device, a digital form comprising a plurality of fields;
receiving, from the first user device, form data associated with one or more fields of the plurality of fields;
associating the form data with an identifier;
receiving, from a second user device or the first user device, a request for the form data, wherein the request includes the identifier; and
transmitting, and in response to receiving the request, the form data to the second user device to populate the one or more fields of the plurality of fields.

18. The non-transitory computer-readable device of claim 17, wherein the operations further comprise:
storing the form data in a data store;
detecting a state of the digital form; and
in response to determining that the state of the form is submitted, purging the form data from the data store.

19. The non-transitory computer-readable device of claim 17, wherein the operations further comprise:
generating a quick response (QR) code associated with the form data, wherein the QR code includes the identifier.

20. The non-transitory computer-readable device of claim 17, wherein the operations further comprise:
generating a uniform resource locator (URL), wherein the URL specifies the identifier of the digital form, and wherein the URL is transmitted to the second user device by way of one or more of: e-mail, instant messaging, Bluetooth, or near field communication.
